(19) United States
(12) Patent Application Publication
(10) Pub. No.: US 2004/0258864 A1
(43) Pub. Date: Dec. 23, 2004

(54) Flexible pressure vessels

(75) Inventors: Keith A. Triebold, Hudson, WI (US); George J. Clements, Afton, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/465,203

(22) Filed: Jun. 19, 2003

(51) Int. Cl. B32B 31/00; B32B 11/02

(52) U.S. Cl. 428/35.2; 428/124; 156/226; 156/292

(57) ABSTRACT

Provided are a flexible pressure vessel, methods of making and using, and kits comprising the flexible pressure vessel. The flexible pressure vessel comprises a first and second layer, each comprising a flexible, liquid impervious material having a plurality of edges. A first edge of the first layer is bonded to a first edge of the second layer by a fold-over seal, and a second edge of the first layer is bonded to a second edge of the second layer with a fold-over seal.

### FIELD

The present invention pertains to flexible pressure vessels.

### BACKGROUND

Materials may be held in a wide variety of primary containment vessels including glass and plastic vials. While such vessels may be suitable for routine handling of the materials, they may not be suitable for transporting the materials by, for example, air or road. During transportation, the primary containment vessels may be placed inside a supplementary packaging vessel. A packaging vessel may be used to cushion the primary containment vessel from shock or vibration arising during transport. In the event that the primary containment vessel breaks or leaks, the packaging vessel may also prevent any material from being released into the environment.

Shippers currently use rigid molded plastic containers as supplementary packaging vessels to protect the primary containment vessels and to prevent material from entering the environment. Although these containers are well suited for transporting multiple samples, they may become economically unacceptable when samples are shipped in small numbers. The container's cost relative to the need to ship the sample may preclude its use. Further, the non-collapsible nature of the rigid containers can pose storage and shipping problems.

Flexible vessels, for example plastic bags, also are used as supplementary packing vessels. Although the flexible vessels when sealed can isolate their contents from the surrounding environment, some flexible vessels suffer from the disadvantage of not being able to maintain an internal pressure load that is even minimally higher than the ambient surrounding pressure. The sealing mechanisms, whether mechanical or adhesive, are susceptible to failure when confronted with internal pressure loads applied to the containment vessel. Such flexible vessels may not be suitable for air transport where the low ambient surrounding pressure may result in a substantial internal pressure load.

There is a continuing need for improved flexible vessels for use as supplemental packaging, particularly flexible pressure vessels that are able to withstand the substantial internal pressure loads that may be encountered during air transport.

### SUMMARY

Briefly, in one aspect, the present invention provides a flexible pressure vessel comprising a first layer comprising a flexible, liquid impervious material having a plurality of edges and a second layer comprising a flexible, liquid impervious material having a plurality of edges, wherein a first edge of the first layer is bonded to a first edge of the second layer by a fold-over seal, and wherein a second edge of the first layer is bonded to a second edge of the second layer with a fold-over seal.

In some embodiments, the first and second layers comprise distinct pieces of a flexible, liquid impervious material.

In some embodiments, a single piece of a flexible, liquid impervious material is folded to form the first and second layers.

In another aspect, the present invention provides a method of making a flexible pressure vessel. First and second layers, each comprising a flexible, liquid impervious material having a plurality of edges, are provided. The first layer is placed adjacent the second layer. A first edge of the first layer is bonded to a first edge of the second layer with a fold-over seal, and a second edge of the first layer is bonded to a second edge of the second layer with a fold-over seal.

In yet another aspect, the present invention provides a method of packaging a material for transport. A first flexible pressure vessel, constructed from a flexible, liquid impervious, material, and having a plurality of bonded edges and an internal containment portion accessible through an unbonded edge, is provided. A second container holding samples of material is placed in the containment portion of the first flexible pressure vessel through the unbonded edge, and the unbonded edge is bonded. At least two edges of the flexible pressure vessel are bonded with fold-over seals.

In yet another aspect, the present invention provides a kit comprising at least one flexible pressure vessel comprising a first layer comprising a flexible, liquid impervious material having a plurality of edges and a second layer comprising a flexible, liquid impervious material having a plurality of edges, wherein a first edge of the first layer is bonded to a first edge of the second layer by a fold-over seal, and wherein a second edge of the first layer is bonded to a second edge of the second layer with a fold-over seal. The kit further comprises at least one of: instructions; an indicating device; a second container for holding samples of material, wherein the second container can be placed inside the first flexible vessel through the opening; and a container capable of holding the plurality of flexible pressure vessels.

An advantage of at least one embodiment of the flexible pressure vessels of the present invention is an ability to withstand an internal pressure load.

The above summary of the present invention is not intended to describe each discussed embodiment of the present invention.

### BRIEF DESCRIPTION OF THE DRAWINGS

FIG. 1a is a cross-sectional view of a seal in a prior art flexible vessel.

FIG. 1b is a cross-sectional view of the seal of FIG. 1a subject to an internal pressure load.

FIG. 2a is a cross-sectional view of a fold-over seal in a flexible pressure vessel in accordance with an embodiment of the invention.

FIG. 2b is a cross-sectional view of the fold-over seal of FIG. 2a subject to an internal pressure load.

FIG. 3a is a cross-sectional view of one edge of one embodiment of a flexible pressure vessel of the present invention prior to completing a fold-over seal.

FIG. 3b is a cross-sectional view of an exemplary embodiment of a single fold-over seal useful in the flexible pressure vessels of the present invention.

FIG. 3c is a cross-sectional view of one exemplary embodiment of a double fold-over seal useful in the flexible pressure vessels of the present invention.

FIG. 3d is a cross-sectional view of one edge of a second exemplary embodiment of a flexible pressure vessel of the present invention prior to completing a fold-over seal.

FIG. 3e is a cross-sectional view of a second exemplary embodiment of a single fold-over seal useful in the flexible pressure vessels of the present invention.

FIG. 4a is an exploded perspective view of a exemplary flexible pressure vessel in accordance with an embodiment of the present invention.

FIG. 4b is a perspective view of the flexible pressure vessel of FIG. 4a prior to sealing the edges.

FIG. 4c is a perspective view of the flexible pressure vessel of FIG. 4a showing the side edges being sealed.

FIG. 4d is a perspective view of the flexible pressure vessel of FIG. 4a showing the bottom edge being sealed.

FIG. 4e is a perspective view of the flexible pressure vessel of FIG. 4a showing the tabs on the bottom edge being sealed.

FIG. 4f is a perspective view of the flexible pressure vessel of FIG. 4a showing the top edge being sealed.

FIG. 5 is a plan view of an exemplary flexible pressure vessel in accordance with an embodiment of the present invention.

### DETAILED DESCRIPTION

The term “flexible” means that the interior chamber is capable of readily conforming when a slight pressure is exerted thereon. Generally, “slight pressure” means less than about 200 kilopascals (kPa), preferably less than about 100 kPa, more preferably less than about 50 kPa. In some embodiments, slight pressure may be less than about 20 kPa, e.g., less than 5 kPa.

The term “pressure differential” means a difference in pressure between the interior and exterior of a vessel. Useful flexible pressure vessels are able to withstand a pressure differential of at least 35 kilopascals (kPa) (e.g., at least 70 kPa, or at least 100 kPa) for at least 10 minutes (e.g., at least 15 minutes, or at least 30 minutes). Failure to withstand a pressure differential may occur if the material used to create a vessel lacks sufficient tensile strength. Failure to withstand a pressure differential may also occur if the seals at the edges of a vessel are too weak to withstand the forces generated by the pressure differential. In either case, the vessel is incapable of holding an internal pressure load.

The term “liquid impervious” means that substantially all (and preferably all) of a liquid present in the flexible pressure vessel remains in the flexible pressure vessel for at least a desired period of time. The desired period of time may vary depending on the application. Generally, the desired period of time will be at least about 15 minutes (e.g., at least about 30 minutes.) In some embodiments, the desired period of time may be substantially longer (e.g., hours, days, or even longer.) Typical liquid impervious materials include, for example, polymer films such as polyolefins and polyesters.

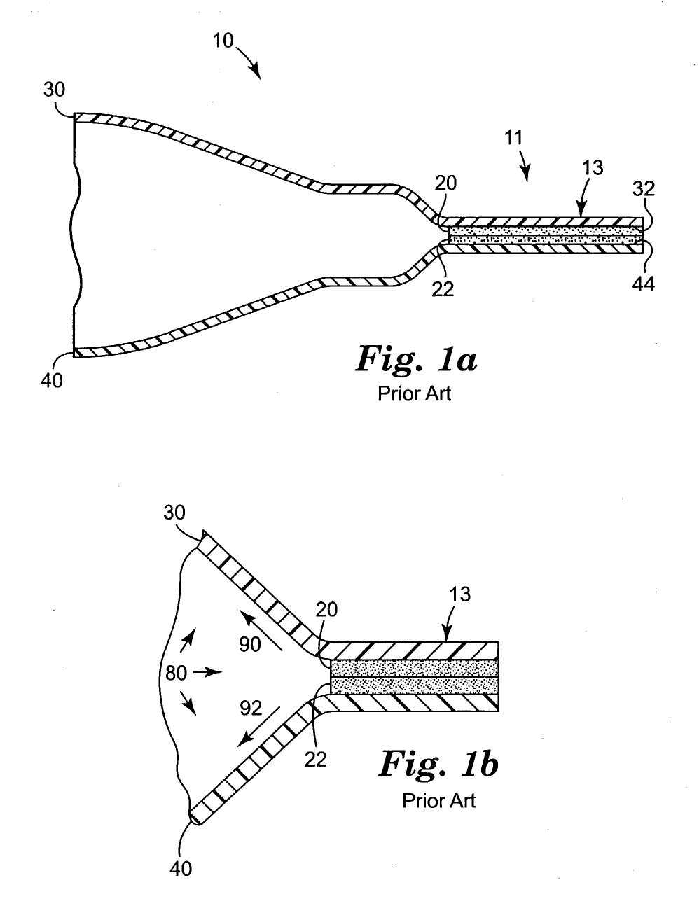

With reference to FIG. 1a-1b, one edge 11 of a flexible vessel 10 of the prior art is shown. The flexible vessel 10 is formed from first layer 30 and second layer 40. A seal 13 is formed along edge 11 by bonding adhesive 20, located on surface 32 of first layer 30, to adhesive 22, located on surface 44 of second layer 40. Alternatively, seal 13 could be formed by a single adhesive layer, or seal 13 could be formed by heat-sealing surface 32 of first layer 30 to surface 44 of second layer 40, in which case adhesive 20 may not be required.

An internal pressure load 80 causes flexible vessel 10 to expand. The internal pressure load may be the result of a pressure differential arising, for example, from a decrease in the external pressure as occurs when, for example, a vessel is transported in an aircraft. The expansion of flexible vessel 10 causes first layer 30 to move away from the second layer 40. This subjects seal 13 to T-Peel forces 90 and 92, which may lead to failure of seal 13.

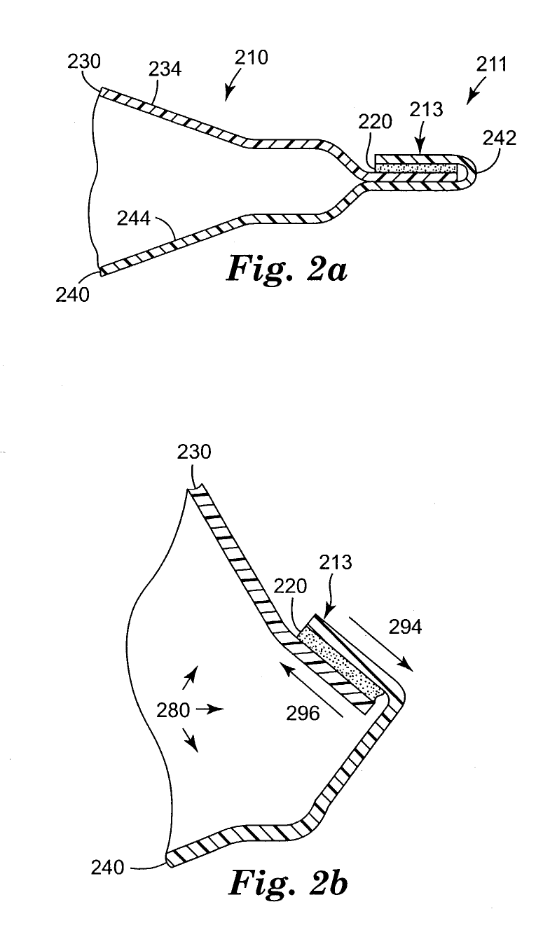

With reference to FIG. 2a-2b, one edge 211 of a flexible pressure vessel 210 in accordance with one embodiment of the invention is shown. A single fold-over seal 213 is formed along edge 211 by folding flap 242 of second layer 240 around first layer 230 and bonding surface 244 of second layer 240 to surface 234 of first layer 230 with adhesive 220. In some embodiments, an alternate bonding means (e.g., heat-sealing or ultrasonic welding) may be used to bond surface 244 of second layer 240 to surface 234 of first layer 230.

An internal pressure load 280 causes flexible pressure vessel 210 to expand. The expansion of flexible pressure vessel 210 causes first layer 230 to separate from second layer 240. This subjects seal 213 to shear forces 294 and 296, which may lead to failure of the seal.

Generally, a seal subjected to shear forces can withstand greater forces than a seal subjected to T-peel forces. Generally, the strength of a seal subjected to shear forces may be increased by, for example, increasing the thickness of the adhesive layer; increasing the bond area by, for example, increasing the length and/or the width of the bond; increasing the strength of the adhesion force between the adhesive and the substrate to which it is bonded by, for example, modifying the surface of the substrate by, e.g., corona treatment, flame treatment, electron beam treatment, chemical etching, or the application of primers; and/or increasing the internal strength of the adhesive by, for example, cross linking the adhesive.

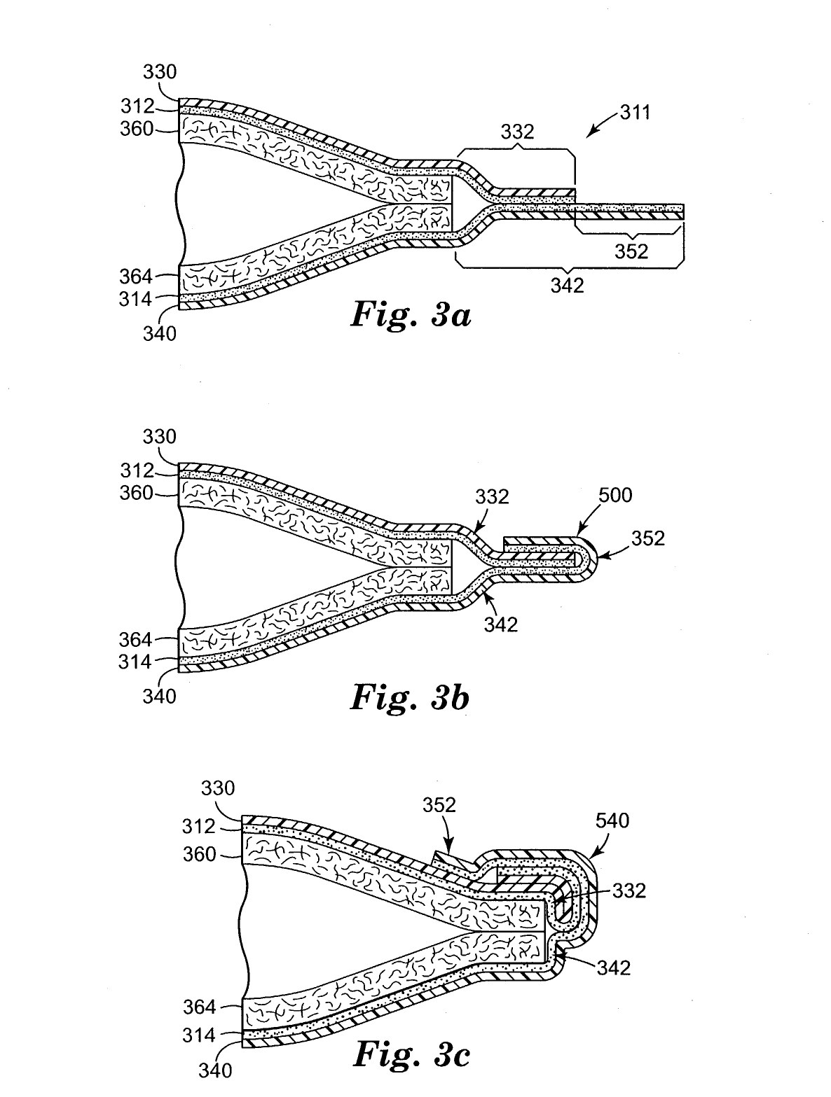

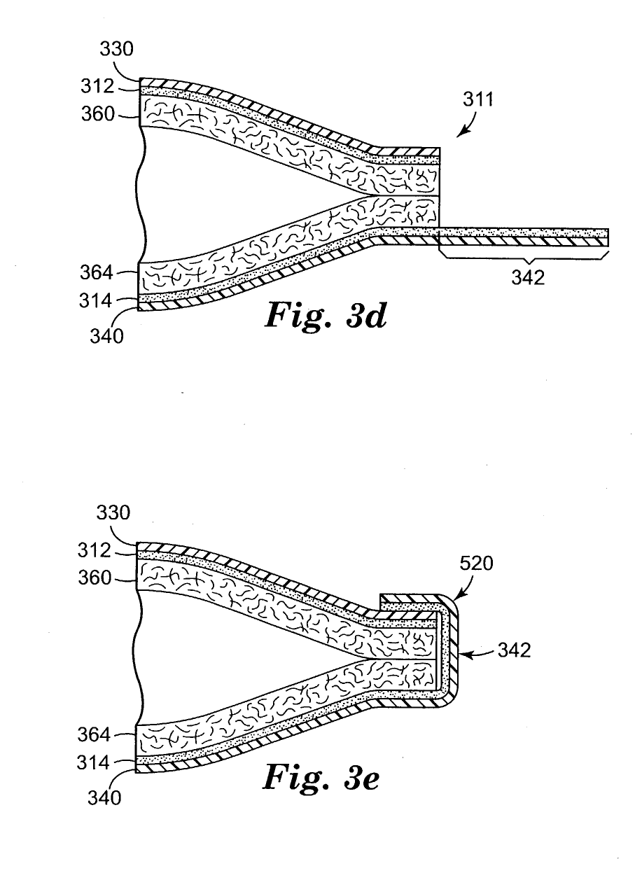

With reference to FIG. 3a and 3b, an exemplary embodiment of a single fold-over seal 500 useful in some embodiments of the present invention is shown. One edge 311 of a flexible pressure vessel 310 in accordance with one embodiment of the invention is shown in FIG. 3a. First sorbent material 360, is bonded to first layer 330 by adhesive 312. First layer 330 and adhesive 312 extend beyond first sorbent material 360, forming side flap 332. Similarly, second sorbent material 364 is bonded to second layer 340 by adhesive 314. First sorbent material 360 and second sorbent material 364 may comprise the same or different materials. Second layer 340 and adhesive 314 extend beyond second sorbent material 364 forming side flap 342. Side flap 332 is bonded to a portion of side flap 342 by adhesives 312 and 314. Second layer 340 and adhesive 314 extend beyond first layer 330 forming side wing 352. Side wing 352 is folded around first layer 330. Adhesive 314 bonds second layer 340 to first layer 330, completing the single fold-over seal 500, as shown in FIG. 3b.

With reference to FIGS. 3a and 3c, an exemplary embodiment of a double fold-over seal 540 useful in some embodiments of the present invention is shown. One edge 311 of a flexible pressure vessel 310 in accordance with one embodiment of the invention is shown in FIG. 3a. Side flap 342, including side wing 352, are folded around first layer 330. This results in side flap 332 being folded back upon first layer 330. Adhesive 314 bonds second layer 340 to first layer 330, completing the double fold-over seal 540, as shown in FIG. 3c.

With reference to FIG. 3d and 3e, a second exemplary embodiment of a single fold-over seal 520 useful in some embodiments of the present invention is shown. One edge 311 of a flexible pressure vessel 310 in accordance with one embodiment of the invention is shown in FIG. 3d. First sorbent material 360 is bonded to first layer 330 by adhesive 312. First layer 330 and adhesive 312 do not extend beyond first sorbent material 360, thus no flap is formed. Second sorbent material 364 is bonded to second layer 340 by adhesive 314. Second layer 340 and adhesive 314 extend beyond second sorbent material 364 forming side flap 342. Side flap 342 is folded around first layer 330. Adhesive 314 bonds second layer 340 to first layer 330, completing the single fold-over seal 520, as shown in FIG. 3e.

Additional fold-over seals may be formed by continuing to fold second layer 340 and/or first layer 330 back upon themselves. Additional adhesive layers and/or alternate bonding means may be required to achieve a bond between adjacent layers in order to achieve higher-order fold-over seals (e.g., triple fold-over seals, quadruple fold-over seals, etc.).

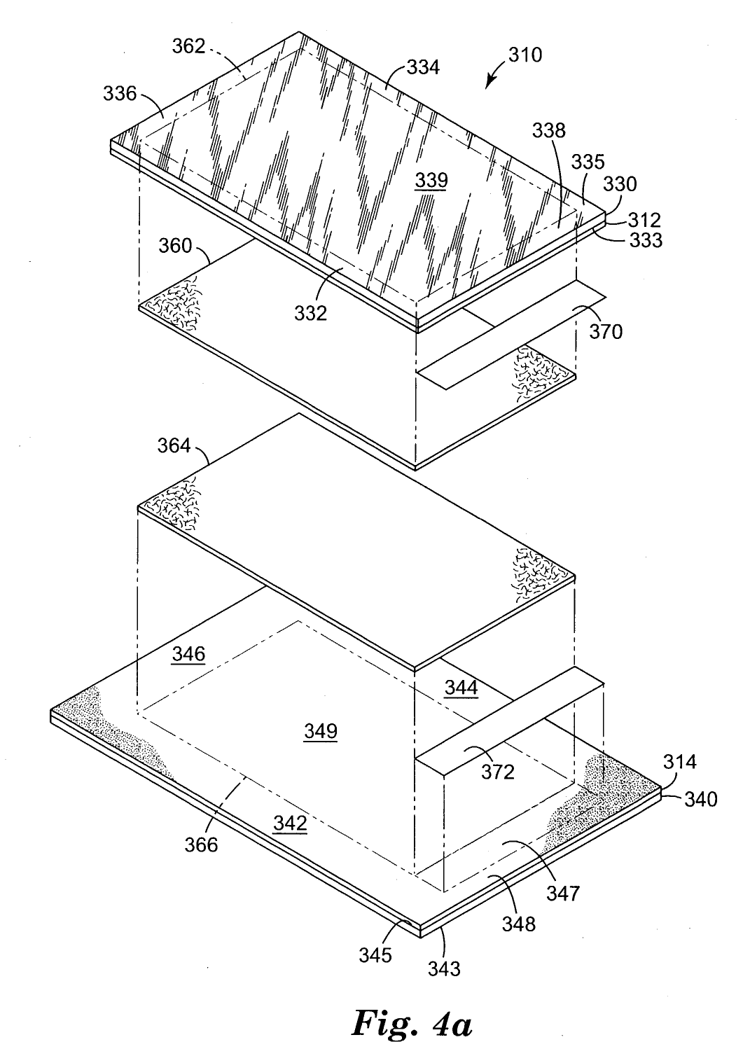

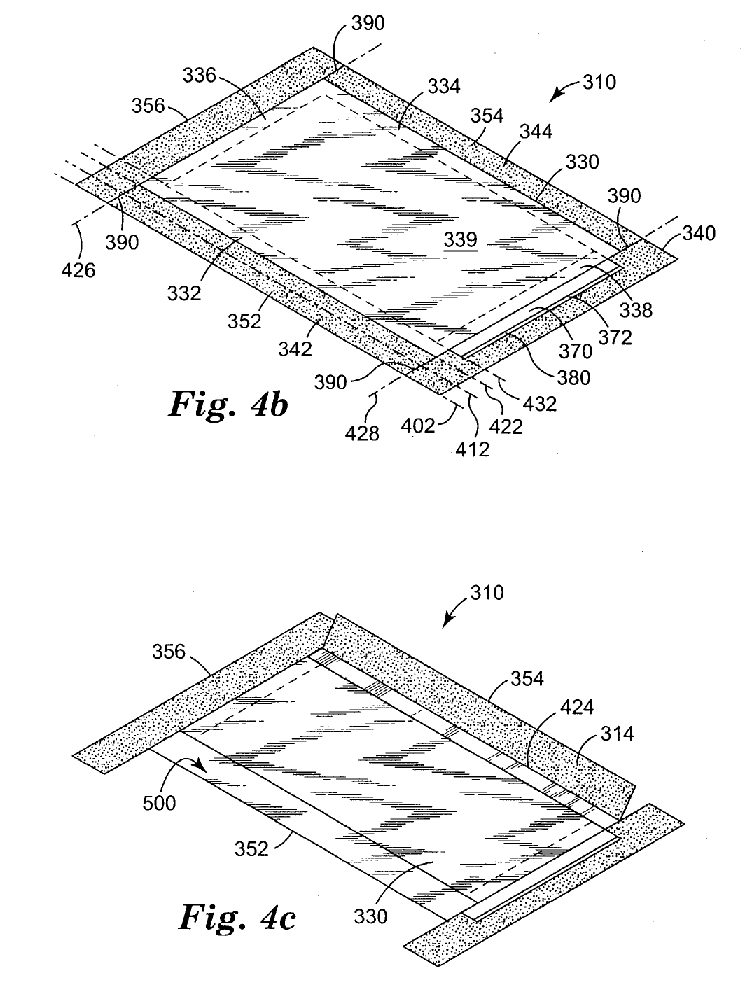

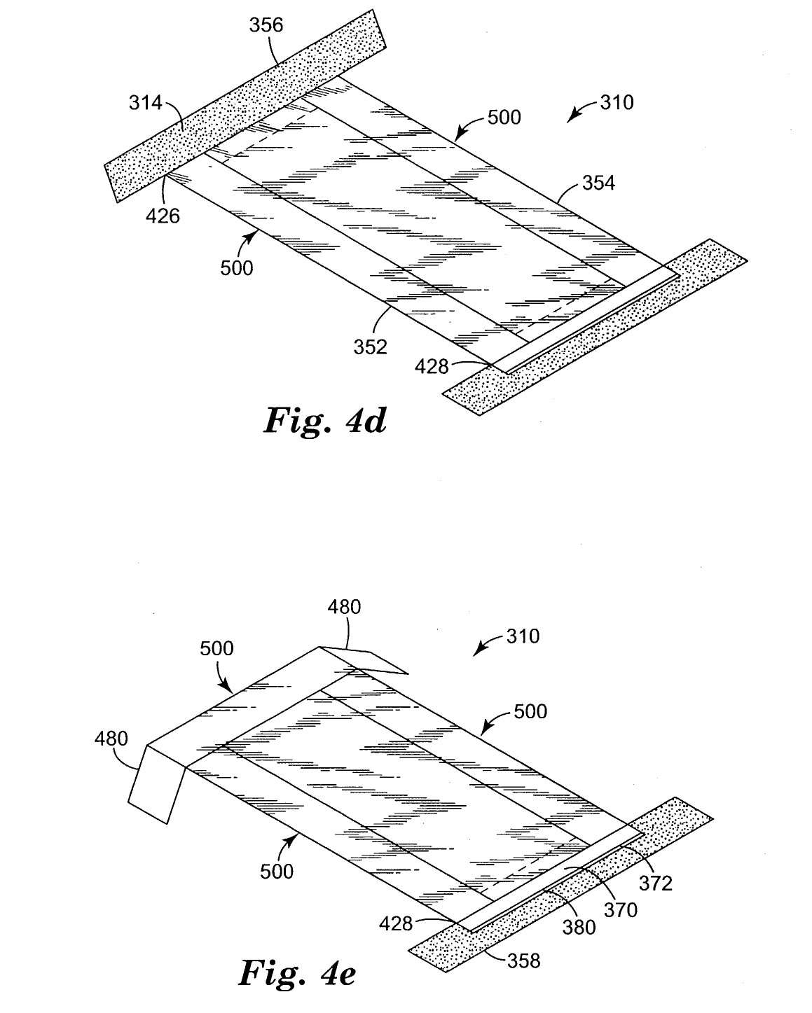

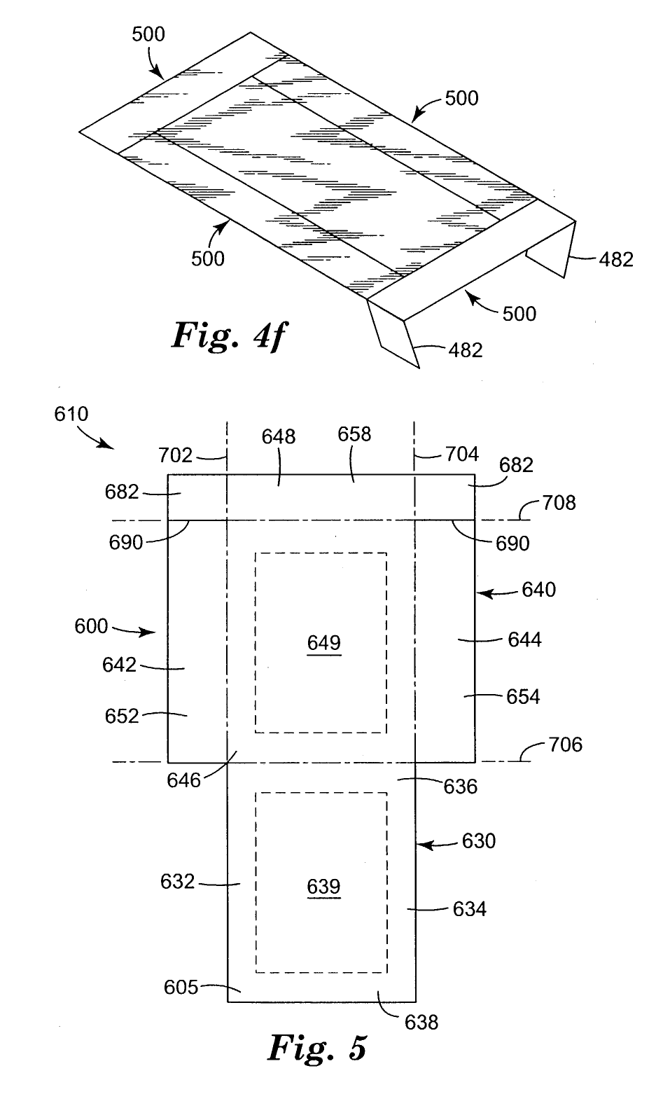

With reference to FIG. 4a-4f, one embodiment of the flexible pressure vessel 310 of the invention is shown. Adhesive 312 covers the second surface 333 of first layer 330. A first sorbent material 360, bonded to the adhesive 312, covers the center area 339 of first layer 330. Side flaps 332 and 334, bottom flap 336, and top flap 338 of first layer 330 extend beyond the perimeter 362 of first sorbent material 360. An optional release liner 370 covers the adhesive 312 on top flap 338. In some embodiments, release liner 370 extends beyond top flap 338. In some embodiments, no release liner is present. In some embodiments, adhesive 312 on top flap 338 is detackified, by for example, applying coating (e.g., shellac, talc, or ink) over adhesive 312

Adhesive 314 covers the first surface 345 of second layer 340. A second sorbent material 360, bonded to adhesive 314, covers center area 349 of second layer 340. Side flaps 342 and 344, bottom flap 346, and top flap 348 extend beyond the perimeter 366 of second sorbent material 364. An optional release liner 372 covers adhesive 314 in area 347 of second layer 340. In some embodiments, no release liner is present. In some embodiments, adhesive 314 in area 347 of second layer 340 is detackified.

First layer 330 is positioned adjacent second layer 340 such that first sorbent material 360 substantially superimposes second sorbent material 364. The adhesive 312 on the second surface 333 of first layer 330 in the areas defined by side flaps 332 and 334, and bottom flap 336 is bonded to the adhesive 314 on the first surface 345 of second layer 340 in a portion of the areas defined by side flaps 342 and 344, and bottom flap 346, respectively. Wings 352, 354, and 356, are the portions of side flaps 342 and 344, and bottom flap 346 of second layer 340, respectively, that are not bonded to side flaps 332 and 334, and bottom flap 336 of first layer 330.

Release liners 370 and 372 prevent adhesive 314 in the area 347 of second layer 340, and adhesive 312 on top flap 338 of first layer 330 from bonding together. This creates an opening 380 through which materials (not shown) can be placed in flexible pressure vessel 310.

In some embodiments, slits 390 are formed in side flap 342. Slits 390 are cut through second layer 340 and adhesive 314, extending from edge 402 of side flap 342, to edge 422 of side flap 332. In some embodiments, slits 390 may extend only to reference line 412 located between edge 402 of side flap 342 and edge 422 of side flap 332. In some embodiments, slits 390 may extend beyond edge 422 of side flap 332 to as far as reference line 432, located at perimeters 362 and 366 of first and second sorbent materials 360 and 364, respectively. To the extent that they extend beyond edge 422, slits 390 are formed in first layer 330 and adhesive 312, as well as in second layer 340 and adhesive 314. In some embodiments, slits 390 may extend beyond reference line 432, in which case first sorbent material 360 and second sorbent material 364 may have to be slit as well. In some embodiments, slits 390 are also present in side flap 344.

If slits 390 do not extend beyond edge 422 of side flap 332, and only second layer 340 is folded around layer 330, a single fold-over seal 500, as shown in FIG. 3b, may be formed. If slits 390 extend beyond edge 422 of side flap 332, and both first layer 330 and second layer 340 are folded, then a double fold-over seal 540, as shown in FIG. 3c, may be formed.

In some embodiments, slits 390 are aligned with top edge 428 and bottom edge 426 of first layer 330. However, in some embodiments, slits 390 may be parallel to, but offset from, top edge 428 and/or bottom edge 426 of first layer 330. In some embodiments, slits 390 are not present.

As shown in FIG. 4c, side wing 352 of second layer 340 is folded around first layer 330. A single fold-over seal 500, is formed by bonding adhesive 314 in the region defined by wing 352 on first surface 345 of second layer 340 to first surface 335 of first layer 330. A single fold-over seal 500 is also formed by folding side wing 354 of second layer 340 around first layer 330 along edge 424, and bonding first surface 345 of second layer 340 to first surface 335 of first layer 330 with adhesive 314.

As shown in FIG. 4d and 4e, bottom wing 356 of second layer 340 is folded around first layer 330 along edge 426. A single fold-over seal 500 is formed by bonding adhesive 314 in the region defined by bottom wing 356 on first surface 345 of second layer 340 to first surface 335 of first layer 330.

In some embodiments, bottom tabs 480 are folded around second layer 340 to further seal the flexible pressure vessel 310. When bottom tabs 480 are folded, adhesive 314 in the regions defined by bottom tabs 480 on first surface 345 of second layer 340 is bonded to second surface 343 of second layer 340. In some embodiments, bottom tabs 480 may be removed.

Materials (not shown) may be placed in the flexible pressure vessel 310 through opening 380. A preliminary seal is formed by removing release liners 370 and 372 and bonding adhesive 312 on top flap 336 of first layer 330 to the adhesive 314 in the area 347 of the second layer 340. Wing 358 is the portion of top flap 348 that is not bonded to top flap 338. In some embodiments, a second release liner (not shown) may cover adhesive 314 on top wing 358 of second layer 340.

Top wing 358 is folded around first layer 330 along edge 428. A single fold-over seal 500 is formed by bonding adhesive 314 in the area defined by top wing 358 on first surface 345 of second layer 340 to first surface 335 of first layer 330. In some embodiments, top tabs 482 are folded around second layer 340 to further seal the flexible pressure vessel 310. Adhesive 314 in the regions defined by tabs 482 on first surface 345 of second layer 340 will bond to second surface 343 of second layer 340. In some embodiments, top tabs 482 may be removed.

With reference to FIG. 5 another embodiment of a flexible pressure vessel 610 of the present invention is shown. Surface 605 of substrate 600 is coated with adhesive (not shown). First layer 630 of the flexible pressure vessel 610 comprises the portion of substrate 600 below fold line 706. Second layer 640 of flexible pressure vessel 610 comprises the portion of substrate 600 above fold line 706.

A sorbent material (not shown) covers center area 639 of first layer 630. Side flaps 632 and 634, bottom flap 636, and top flap 638 are those portions of first layer 630 that are not covered by the sorbent material (not shown). In some embodiments, the sorbent material may cover all of first layer 630.

A sorbent material (not shown) covers center area 649 of second layer 640. Side flaps 642 and 644, bottom flap 646, and top flap 648 are those portions of second layer 640 that are not covered by the sorbent material (not shown).

In some embodiments, the sorbent material may optionally be omitted from one or both layers, e.g., those embodiments using pattern-coated adhesives, transfer tapes, double-coated tapes, heat-seals, or detackified areas.

First layer 630 is folded along fold line 706, such that center areas 639 of first layer 630 is substantially superimposed adjacent center area 649 of second layer 640. Side flaps 632 and 634, and bottom flap 636 of first layer 630 are bonded to side flaps 642 and 644, and bottom flap 646 of second layer 640, respectively. Release liners (not shown) prevent top flap 638 of first layer 630 from bonding to second layer 640.

Slits 690 are formed in side flaps 642 and 644 of second layer 640 along line 708. The location and length of slits 690 can be adjusted as desired, as discussed above. Side wings 652 and 654, of second layer 640 are folded around first layer 630 at fold lines 702 and 704, respectively. Side wings 652 and 654 of second layer 640 are bonded to first layer 630 to form fold-over seals (not shown).

After placing material (not shown) into the flexible pressure vessel 610, the release liners (not shown) are removed, and top flap 638 of first layer 630 is bonded to second layer 640. Top wing 658 of second layer 640 is folded around first layer 630 at fold line 708 and bonded to first layer 630 forming a fold-over seal (not shown). Tabs 682 are folded around and bonded to second layer 640. In some embodiments, tabs 682 may be removed.

It is to be understood that alternative embodiments of a flexible pressure vessel may be constructed using any combination of single, double or higher-order fold-over seals, including, for example, single fold-over seals 500 and 520, and double fold-over seal 540, as shown in FIG. 3b, 3e and 3c, respectively. For example, some edges may be bonded using single fold-over seals, while other edges are bonded with double fold-over seals. In some embodiments, not all edges are bonded with fold-over seals.

It is to be understood that, by varying the dimensions and placement of the first layer relative to the second layer, alternative embodiments of a flexible pressure vessel may be formed wherein some or all of the bonds are formed by folding the first layer relative to the second layer.

In some embodiments, the bottom wing may be folded prior to folding one or both side wings. In some embodiments, the location and direction of the slits may be altered so that tabs extend from one or both side wings. That is, the slits may be made perpendicular to the top edge and/or the bottom edge. In some embodiments, the slits may be made at an angle relative to the top edge and/or the bottom edge.

In some embodiments, adhesive is not applied to the entire second surface of the first layer and/or first surface of the second layer. Rather, adhesive may be applied only to selected areas, e.g., to areas where a bond is desired. For example, adhesive may be applied only to the flaps and/or wings, or to portions of the flaps and/or wings. In some embodiments, the adhesive may be detackified in areas.

In some embodiments, alternate sealing means (e.g., heat seals, ultrasonic welds and the like) may be used to form the seals, e.g., single and double fold-over seals. Known coatings may be applied to the surfaces of the first and second layers to aid in forming seals of the desired strength.

In some embodiments, the seals may be reinforced by applying tape (e.g., an adhesive-coated substrate (e.g., cloth, paper, polymer film, non-woven webs, and the like)) over a portion or all of the seal.

In some embodiments, the sorbent materials may not be required. However, in addition to masking portions of the adhesive, the sorbent materials also provide additional protection to materials placed in the flexible pressure vessel (e.g., shock absorption and wicking of spilled liquids).

In some embodiments, the sorbent material may be bonded to an adhesive over the entire second surface of the first layer. When the first layer is positioned adjacent the second layer, no bond will be formed between the adhesives on the first and second layers. If the second layer is folded over and bonded to the first layer, a single fold-over seal as shown in FIG. 3e is formed.

In some embodiments, the sorbent layer may be bonded to the first and/or second layer with an alternate bonding means (e.g., heat seal). In some embodiments, the sorbent layer may be present but not bonded to the first and/or second layers.

In some embodiments, the first and/or second layers may have fewer than four edges (e.g., three edges). In some embodiments, the first and/or second layers may have more than four edges (e.g., five edges, six edges, et cetera). In some embodiments, the first and/or second layer may have one or more curved edges.

The first and second layers of the flexible pressure vessel are constructed of a material that provides the desired levels of strength and liquid impermeability. In some embodiments, it may be desirable that the material resist vapor (e.g., oxygen, carbon dioxide, and/or water vapor (e.g., steam)) transfer as well. In some embodiments, the material may be a metal foil. In some embodiments, the material may be a polymeric film. In some embodiments, the polymeric film may comprise a polyolefin film (e.g., polypropylene, polyethylene). In some embodiments, the polymeric film may comprise a polyester film (e.g., polyethylene terephthalate (PET)). In some embodiments, the material has a tensile strength of at least 20 Newtons per centimeter (N/cm) (e.g., at least 40 N/cm, at least 60 N/cm, or at least 80 N/cm). Tensile strength can be determined in accordance with ASTM D882-88, Method A.

In some embodiments, the first and/or second layer may comprise a multi-layer material. The multi-layer material may comprise, for example, polyolefin layers, polyester layers, adhesive layers, and/or metallic layers. For example, one layer may provide the required strength properties, while a second layer may provide the required liquid impermeability.

In some embodiments, the first and/or second layer may comprise functional or decorative coatings (e.g., primers, inks, heat seal coatings, antistatic coatings, anti-slip coatings, print receptive coatings, and the like). In some embodiments, one or more surfaces of the first and second layer may be treated to improve adhesion by, for example, corona discharge, flame, electron beam, chemical etching and the like.

The sorbent material also may serve as cushioning means to dampen shock. Cushioning materials are particularly useful when a fragile article, for example, a glass container, is shipped in the flexible pressure vessel. The sorbent/cushioning material may be, for example, woven or nonwoven webs of natural and/or synthetic fibers. An exemplary sorbent material is nonwoven web of melt blown microfibers, which also contains microfiber microwebs, such as described in U.S. Pat. No. 4,813,948 to Insley.

The sorbent material also may include other ingredients in addition to the sorbent medium. For instance, a nonwoven web of melt blown microfibers may be loaded with discrete solid particles capable of interacting with (for example, chemically or physically reacting with) a liquid to which the particles are exposed. Such particles can remove a component from a liquid by sorption, chemical reaction, or amalgamation or a catalyst may be employed to convert a potentially hazardous material to a harmless material. An example of a particle-loaded nonwoven web of microfiber is disclosed in U.S. Pat. No. 3,971,373 to Braun, where discreet solid particles of activated carbon, alumina, sodium bicarbonate, and/or silver are uniformly dispersed throughout and are physically held in the web to absorb a liquid.

Also, additives such as dyes, pigments, fillers, surfactants, abrasive particles, light stabilizers, fire retardants, absorbents, medicaments, disinfectants, gelling agents, et cetera, also may be added to the web by introducing such components to the fiber-forming molten polymers or by spraying them onto the fibers after the web has been collected.

The adhesive of the present invention may be any known adhesive provided the shear strength of the seal is sufficient to withstand the desired internal pressure force. The particular adhesive selected may depend on a variety of factors including, for example, the desired shear strength of the seal and the composition of the flexible materials used to create the flexible pressure vessel.

The adhesive may be, for example, a pressure sensitive adhesive (PSA), a thermosetting adhesive, a moisture cured adhesive, a thermal cured adhesive, a thermally activated adhesive, or a non-tacky adhesive. In some embodiments, a PSA may be preferred. Suitable pressure sensitive adhesives include, for example, acrylics, vinyl ethers, natural or synthetic rubber-based materials, poly(alpha-olefins), and silicones.

The adhesive may be crosslinked by any known means including, for example, ultraviolet light, thermal energy or e-beam. The adhesive may include additives such as, for example, pigments, dyes, plascticizers, fillers, stabilizers, tackifiers, ultraviolet light absorbers, antioxidants, processing oils, and the like.

The adhesive may be applied by any known means including, e.g., pattern coating, spray coating, gravure coating, roll coating, or applying adhesive transfer tapes or double-coated tapes.

A method of using the flexible pressure vessel described above for the transport of materials can comprise the following steps:

a) providing a first flexible pressure vessel constructed from a flexible, liquid impervious material, the flexible pressure vessel having a plurality of sealed edges and an internal containment portion accessible through an opening at an unsealed edge;

b) placing a second container holding samples of material in the containment portion of the first flexible pressure vessel through the opening at the unsealed edge; and

c) sealing the opening at the unsealed edge, wherein at least two edges of the flexible pressure vessel are sealed with fold-over seals.

A multitude (e.g., two or more) sealed flexible pressure vessels containing materials may be packaged in a third article or final shipping container such as a crate, cardboard box, plastic cooler, et cetera. The packaged flexible pressure vessels may be transported to a distant location. Flexible pressure vessels of this invention are particularly useful for air transport because they can withstand the pressure differentials that occur as altitude increases.

In some embodiments, the flexible pressure vessels of the present invention further comprise labels for indicating, for example, the contents of the flexible pressure vessel, the date, and shipping information. In some embodiments, the flexible pressure vessels of the present invention further comprise indicating devices, such as, for example, tamper indicating devices, temperature indicating devices, pressure indicating devices, shock indicating devices, and the like.

The flexible pressure vessels of the present invention may be provided as kits comprising, for example, one or more flexible pressure vessels, and one or more of the following: instructions for the use of a the flexible pressure vessel, labels, indicating devices, secondary containers for holding materials for insertion into the flexible pressure vessel, and tertiary containment vessels for holding one or more sealed flexible pressure vessels.

The following specific, but non-limiting, examples will serve to illustrate the invention. In these examples, all percentages are parts by weight unless otherwise indicated.

### EXAMPLES

Sample Descriptions

Examples E1-E3 were made by using a 51 micrometer (2 mil) biaxially oriented polypropylene (BOPP) film, with a 28 micrometers (1.1 mils) thick layer of pressure sensitive, hot-melt, rubber-resin adhesive (SCOTCH 375 tape, available from 3M Company, located in St. Paul, Minn.). From a 12-inch wide roll stock of this tape, a first and second piece were cut to form the first layer and second layer of a flat, flexible pressure vessel. The first tape layer was 15.2 cm (6 inches) wide by 22.9 cm (9 inches) long, while the second layer was 22.9 cm (9 inches) wide by 30.5 cm (12 inches) long. Two sorbent layers of copy paper (HAMMERMILL CopyPlus COPY PAPER, available from International Paper, located in Memphis, Tenn.) were cut 15.2 cm (6 inches) wide by 17.8 cm (7 inches) long. One sorbent layer was centered on the adhesive side of each of the first and second tape layers. The sorbent layer centered on the first tape layer was positioned such that the width of the sorbent layer matched the width of the first tape layer, leaving a 2.5 cm (1 inch) wide portion of the first tape layer exposed on each end of the 17.8 cm (7 inches) length of the sorbent layer.

One strip of silicone release liner measuring 15.2×2.5 cm (6×1 inch) was placed over one of the exposed areas of the first tape layer. Another 15.2×2.5 cm (6×1 inch) strip of silicone release liner was centered in the width of the second tape layer and positioned 3.8 cm (1.5 inch) in from the top edge of the second tape layer, so as to be directly opposite the release liner of the first layer. A third, larger strip of silicone release liner measuring 22.9×2.5 (9×1 inches) was placed along the top edge of the second layer, adjacent and parallel to the other release liner on the second layer.

The first layer, to which was attached a sorbent layer and a strip of silicone release liner, was centered and attached to the second layer. The two 15.2×2.5 cm (6×1 inch) strips of release liners preserved the opening of the vessel. Four equal cuts of 3.8 cm (1.5 inch) were made parallel to the 22.9 cm (9 inch) width of the second layer, and in 3.8 cm (1.5 inches from the end of the second layer, as shown in FIG. 4b, to create the side wings, which were folded over the first layer as shown in FIG. 4c. The sides of the vessel were thus sealed by a single fold-over seal with no adhesive-to-adhesive contact between the first and second layers, as shown in FIG. 3e. The bottom of the vessel was sealed by folding the bottom wing of the second layer over the first layer and wrapping the bottom wing tabs around the vessel and back onto the second layer. In this example, the bottom of the vessel is thus sealed, as shown in FIG. 4d-4e, with a single fold-over seal and a 2.5 cm (1 inch wide) adhesive-to-adhesive bond, similar to FIG. 3b.

When the vessel was ready to be sealed at the top opening, the two 15.2×2.5 cm (6×1 inch) release liners were removed and an adhesive-to-adhesive bond was formed. Finally, the larger release liner on the second layer was removed and the top wing of the second layer was folded over the first layer and the top wing tabs were wrapped around the vessel to bond to the second layer, as shown in FIG. 4f, forming a single fold-over seal with an adhesive-to-adhesive bond, similar to FIG. 3b.

Example E4 was prepared with the same materials and construction as E1, but with the following exceptions. A 51 micrometer (2 mil) biaxially oriented polyester film, with a 39 micrometer (1.4 mil) thick layer of pressure sensitive, hot-melt, rubber-resin adhesive (SCOTCH 355 tape, available from 3M Company) was used instead the of biaxially oriented polypropylene tape for the first and second layers. Also, the sorbent layers were less wide, 10.2×17.8 cm (4×7 inches). Due to the narrower width of the sorbent layers, a 2.5 cm (1 inch) adhesive-to-adhesive bond was formed at the sides of the vessel, ultimately resulting in a single fold-over seal similar to FIG. 3b.

Example E5 was prepared with the same materials and construction as E4 but with the following exceptions. Two identical sorbent layers of 15.2×22.9 cm (6×9 inches) were each centered on the adhesive side of the first and second tape layers. The first layer measured 17.8×25.4 cm (7×10 inches) and the second layer measured 22.9×30.5 cm (9×12 inches). Two strips of silicone release liners, each measuring 1.3×15.2 cm (0.5×6 inches), were placed on the first and second tape layers adjacent and parallel to the sorbent layers. The first tape layer was centered and attached to the second tape layer, such that a 1.3 cm (0.5 inch) adhesive-to-adhesive bond was formed between the first and second layers around three sides of the sorbent layers. The silicone release liners preserved the vessel opening at the forth side of the sorbent layer. A third, larger strip of silicone release liner measuring 22.9×2.5 cm (9×1 inches) was placed along the top edge of the second layer, adjacent and parallel to the other release liner on the second layer. Four equal cuts of 3.8 cm (1.5 inch) were made as described in Example E1. Double fold-over seals, such as that shown in FIG. 3c, were made at the sides, bottom and top (opening) by folding the already adhesively sealed first and second tape layers along the four edges of the sorbent layers. This resulted in not only a 1.3 cm (0.5 inch) adhesive-to-adhesive bond but also a 2.5 cm (1 inch) adhesive bond between the adhesive of the second layer and the backside of the first layer.

Example E6-E8 were prepared with the same materials and construction as E5, except biaxially oriented polypropylene (BOPP) packaging tape (SCOTCH 375 tape, available from 3M) was used instead of biaxially oriented polyester tape for the first and second layers.

Example E9 was prepared with the same materials and construction as E8, except that a 30 micrometer (1.2 mil) thick biaxially oriented polypropylene (BOPP) film, with an 18 micrometer (0.7 mil) think layer of pressure sensitive, hot-melt, rubber-resin adhesive (SCOTCH 371 tape, available from 3M) was used instead of the biaxially oriented polyester tape for the first and second layers.

Comparative Example C1 was made by using a 51 micrometer (2 mil) biaxially oriented polypropylene (BOPP) film, with a 28 micrometers (1.1 mils) thick layer of pressure sensitive, hot-melt, rubber-resin adhesive (SCOTCH 375 tape, available from 3M). From a 12-inch wide roll stock of this tape, a first and second piece were cut to form the first layer and second layer of a flat, flexible pressure vessel. The first and second tape layers were cut to 22.9×30.5 cm (9×12 inches). To the adhesive side of each of the first and second tape layers was applied a 10.2×17.8 cm (4×7 inch) piece of white office copy paper (HAMMERMILL CopyPlus COPY PAPER). A sorbent layer was centered on each tape layer. A 2.5 cm (1 inch) border of adhesive remains exposed around the perimeter of the sorbent layer. Two strips of silicone coated release liners, measuring 22.9×2.5 cm (9×1 inch) were placed along the width of one edge of each the first and second tape layers, adjacent to the sorbent layers, along what would be the mouth opening of the flexible pressure vessel being prepared.

The two tape layers with the sorbent layers and release liners were brought together so that adhesive to adhesive contact occurred between the first and second tape layers, on the three sides not covered by release liners to create a flexible bag. The release liners prevented adhesive-to-adhesive contact along the forth side and preserved the opening of the vessel. A pocket or chamber was formed between the sorbent layers. The release liners were removed and the adhesive of both tape layers were brought into contact to seal the flexible container.

Test Methods

The following procedure was followed in order to test a flexible pressure vessel's pressure resistant property. A small hole with a diameter of approximately 1.3 cm (0.5 inch) diameter was cut in the center of one layer of the sample flexible pressure vessel. A custom built coupler was installed in the hole to accommodate a 0.635 cm (0.25 inch) diameter high-pressure air line (POLYFLO tubing 44-P-¼, available from Flowline Components Inc., located in Baltimore, Md.). The coupler consisted of a 0.635 cm (0.25 inch) stainless steel compression fitting including two flouro-polymer washers and two soft rubber washers, which provided an air-tight (i.e. high pressure-resistant) inlet port into the flexible vessel. The high-pressure air line was connected via a quick-disconnect coupler to a pressure regulator, which in turn was connected to a source of pressurized air.

Once the custom coupler was installed into the flexible pressure vessel to be tested, the top opening of the flexible pressure vessel was sealed. The flexible pressure vessel was gradually inflated to a target pressure (34 kPa (5 psi), 69 kPa (10 psi) or 103 kPa (15 psi)) over a brief time period of approximately 10-30 seconds. If a sample failed prior to reaching the target pressure, the pressure at the time of the failure is reported. If a sample reached the target pressure, the sample was held at that pressure for a predetermined period of time (15 minutes or 30 minutes). Comparative Examples C1 and Examples E1-E8 were tested according to the above describe procedure. The results are reported in Table 1.

TABLE 1

| | | | Target | | |
|---|---|---|---|---|---|
| | | | Pressure | | |
| Example | Tape# | Seal Type | psi | kPa | Comment |
| E1 | 375 | Single fold | 5 | 34 | Held for 15 minutes |
| | | | | | (slight leak at corners) |
| E2 | 375 | Single fold | 10 | 69 | Held for 15 minutes |
| | | | | | (slight leak at corners) |
| E3 | 375 | Single fold | 15 | 103 | Failed at a corner |
| | | | | | at 69 kPa (10 psi) |
| E4 | 355 | Single fold | 15 | 103 | Held for 15 minutes |
| | | | | | (slight leak in corner) |
| E5 | 355 | Double fold | 15 | 103 | Held for 30 minutes |
| E6 | 375 | Double fold | 5 | 34 | Held for 15 minutes |
| E7 | 375 | Double fold | 10 | 69 | Held for 15 minutes |
| E8 | 375 | Double fold | 15 | 103 | Failed after 30 seconds |
| E9 | 371 | Double fold | 5 | 34 | Held for 15 minutes |
| C1 | 375 | No fold | 15 | 103 | Failed by T-Peel |
| | | | | | at 21 kPa (3 psi) |

Various modifications and alterations of this invention will become apparent to those skilled in the art without departing from the scope and spirit of this invention.

What is claimed is:

1. A flexible pressure vessel comprising:
a first layer comprising a flexible, liquid impervious material having a plurality of edges; and
a second layer comprising a flexible, liquid impervious material having a plurality of edges, wherein a first edge of the first layer is bonded to a first edge of the second layer by a fold-over seal, and wherein a second edge of the first layer is bonded to a second edge of the second layer with a fold-over seal.

2. The flexible pressure vessel of claim 1, wherein the flexible pressure vessel withstands a pressure differential of at least about 34 kilopascals for at least about 15 minutes.

3. The flexible pressure vessel of claim 1, wherein the flexible pressure vessel withstands a pressure differential of at least about 69 kilopascals for at least about 15 minutes.

4. The flexible pressure vessel of claim 1, wherein the flexible pressure vessel withstands a pressure differential of at least about 103 kilopascals for at least about 15 minutes.

5. The flexible pressure vessel of claim 1, wherein the flexible pressure vessel withstands a pressure differential of at least about 103 kilopascals for at least about 30 minutes.

6. The flexible pressure vessel of claim 1, wherein the flexible, liquid impervious material has a tensile strength of at least about 30 Newtons per centimeter.

7. The flexible pressure vessel of claim 1, wherein the flexible, liquid impervious material has a tensile strength of at least 50 Newtons per centimeter.

8. The flexible pressure vessel of claim 1, wherein the flexible, liquid impervious material has a tensile strength of at least 75 Newtons per centimeter.

9. The flexible pressure vessel of claim 1, wherein the flexible, liquid impervious material comprises a polymeric film.

10. The flexible pressure vessel of claim 9, wherein the polymeric film is selected from the group consisting of: polypropylene and polyester.

11. The flexible pressure vessel of claim 1, wherein the flexible, liquid impervious material comprises a multi-layer film.

12. The flexible pressure vessel of claim 1, wherein at least one of the fold-over seals comprises a single fold-over seal.

13. The flexible pressure vessel of claim 1, wherein at least one of the fold-over seals comprises a double fold-over seal.

14. The flexible pressure vessel of claim 1, wherein at least one of the fold-over seals comprises a higher-order fold-over seal.

15. The flexible pressure vessel of claim 1, wherein each edge of the first layer is bonded to a corresponding edge of the second layer by a fold-over seal.

16. The flexible pressure vessel of claim 1, wherein at least one fold-over seal comprises an adhesive.

17. The flexible pressure vessel of claim 16, wherein the adhesive comprises a pressure sensitive adhesive.

18. The flexible pressure vessel of claim 1, wherein at least one fold-over seal comprises a heat seal.

19. The flexible pressure vessel of claim 1, further comprising a sorbent material.

20. A flexible pressure vessel of claim 1, wherein the first layer and the second layer are distinct pieces of a flexible, liquid impervious material.

21. The flexible pressure vessel of claim 1, wherein a single piece of the flexible, liquid impervious material is folded to form the first layer and the second layer.

22. A method of making a flexible pressure vessel comprising the steps of:
providing a first layer comprising a flexible, liquid impervious material having a plurality of edges;
providing a second layer comprising a flexible, liquid impervious material having a plurality of edges;
placing the first layer adjacent the second layer;
bonding a first edge of the first layer to a first edge of the second layer with a fold-over seal; and
bonding a second edge of the first layer to a second edge of the second layer with a fold-over seal.

23. The method of claim 22, further comprising the step of positioning a sorbent material between the first and second layers.

24. A method of making a flexible pressure vessel comprising the steps of:
providing a flexible, liquid impervious material;
folding the flexible, liquid impervious material to a form a first layer having a plurality of edges, and a second layer having a plurality of edges;
bonding a first edge of the first layer to a first edge of the second layer with a fold-over seal;
bonding a second edge of the first layer to a second edge of the second layer with a fold-over seal.

25. A method of packaging a material for transport comprising the steps of:
a) providing a first flexible pressure vessel constructed from a flexible, liquid impervious, the flexible pressure vessel having a plurality of bonded edges and an internal containment portion accessible through an unbonded edge;
b) placing a second container holding samples of material in the containment portion of the first flexible pressure vessel through the unbonded edge; and
c) bonding the unbonded edge, wherein at least two edges are bonded with a fold-over seal.

26. A kit comprising:
a) the flexible pressure vessel of claim I; and
b) one or more of
1) instructions;
2) an indicating device;
3) a second container for holding samples of material, wherein the second container can be placed inside the first flexible vessel through the opening; and
4) a container capable of holding the plurality of flexible pressure vessels.
